(19) United States
(12) Patent Application Publication
(10) Pub. No.: US 2003/0077413 A1
(43) Pub. Date: Apr. 24, 2003

(54) Transparent adhesive note sheet

(76) Inventor: Kumud Shah, Nymbu (KE)

Correspondence Address: Joseph A. Sebolt, SAND & SEBOLT, Aegis Tower, 4940 Munson Street N.W., Suite 1100, Canton, OH, 44718-3615, US

(21) Appl. No.: 10/066,464

(22) Filed: Feb. 1, 2002

Related U.S. Application Data
(60) Provisional application No. 60/335,509, filed on Oct. 23, 2001.

(51) Int. Cl. B32B 9/00

(52) U.S. Cl. 428/40.1; 428/194

(57) ABSTRACT

A note sheet is formed of a transparent material and has first and second sides. The first side is capable of being written on and the second side has a thin layer of a repositionable pressure sensitive adhesive along one edge thereof. The sheets are paper and preferably are formed of a cellulose fiber material and have a thickness in the range of 5 microns and 100 microns. The sheets may be stacked one upon another with the adhesive securing the sheets in the stacked relationship to form a notepad. Subsequent removal of individual sheets from the notepad are suitable for removable mounting on another object.

### BACKGROUND OF THE INVENTION

1. Technical Field

The invention relates to writing sheets and in particular to a note pad containing a plurality of the writing sheets which are formed of a transparent material which are capable of receiving writing on one surface of the sheet and has a repositionable pressure sensitive adhesive along one edge of the second surface for arranging the notes in a stacked relationship and for subsequently attaching individual sheets to an object by the adhesive.

2. Background Information

Well known notepads such as distributed by 3M Company under the trademark POST-IT, comprise a stack of paper sheets, each having a narrow strip of a low tack pressure sensitive repositionable adhesive adjacent one edge on a rear side of the sheets. These sheets can be temporarily adhered to substrates such as documents or other articles, by the small strip of adhesive with the opposite surface being capable of receiving writing thereon. These sheets have a repositionable low tack adhesive and are easily removed from the pad and repositioned on an object such as paper or other surface. However, one difficulty with these known note sheets is that they are opaque. This makes it difficult to read the underlying text material of a document on which the note is applied. This also makes it difficult to photocopy the document on which it is applied since it will not reproduce the underlying information.

Existing repositionable pressure sensitive adhesive notes formed of opaque paper are relatively thick due to the grade of paper used which presents a problem if a relatively large number are used in a document, since it will increase considerably the overall thickness of the edited document.

Therefore, the need exists for an improved adhesive note sheet which is formed of a relatively thin transparent material.

### BRIEF SUMMARY OF THE INVENTION

The invention provides a note sheet formed of a transparent material having a front surface suitable for receiving writing thereon with the opposite surface having a narrow strip of pressure sensitive adhesive adjacent an edge thereof for securing the sheets to an object or a plurality of the sheets in a stacked relationship to form a notepad.

Another aspect of the invention provides the pressure sensitive adhesive with sufficient tackiness enabling the sheet to be repositionable on various items without losing its tackiness and without leaving any residue adhesive on the object to which it was adhered after its removal from the object.

Another feature of the invention is forming the note sheet out of a transparent paper or film, preferably a cellulose fiber material such as a cellulose acetate.

A further feature of the invention is to produce the adhesive note sheet of a relatively thin material having a thickness within the range of 5 microns and 100 microns to prevent a document having a plurality of such sheets attached thereto from becoming excessively thick.

Another aspect of the invention is to provide a transparent adhesive note sheet which can be placed over an object which when photocopied, will enable the underlying material to be visible and which will enable corrections to the underlying material to be made on the top surface of the applied note sheet, thereby providing the reader of the document with a view of the original document as well as the proposed corrections thereto without destroying or removing those portions of the original document which may be subject to correction.

The foregoing advantages, construction and operation of the present invention will become readily apparent from the following description and accompanying drawings.

### BRIEF DESCRIPTION OF THE DRAWINGS

The preferred embodiment of the invention, illustrative of the best mode in which applicant contemplates applying the principles of the invention, is set forth in the following description and is shown in the drawings and is particularly and distinctly pointed out and set forth in the appended claims.

FIG. 1 is a perspective view of a notepad containing a plurality of the transparent note sheets;

FIG. 2 is a perspective view similar to FIG. 1 showing a smaller size notepad containing a plurality of smaller transparent adhesive note sheets in a stacked relationship;

FIG. 3 is an enlarged fragmentary view of the encircled portion of FIG. 1;

FIG. 4 is a perspective view of the adhesive note sheet of the present invention;

FIG. 5 is a diagrammatic view showing one manner in which the transparent adhesive note sheet of the present invention may be utilized; and

FIG. 6 is a diagrammatic plan view showing the transparent adhesive note sheet of the present invention used for editing a document.

Similar numerals refer to similar parts throughout the drawings.

### DETAILED DESCRIPTION OF THE INVENTION

The transparent adhesive note sheet of the present invention is indicated generally at 1, and is shown in FIG. 4. Sheet 1 preferably has a rectangular configuration formed with a first or front side 2 and an opposite back or second side 3. A small strip of a pressure sensitive adhesive 5 extends along an edge 6 of the sheet on back side 3. Adhesive 5 can be various types of adhesives or glues well known in the art such as currently used on opaque paper releasable adhesive notepad sheets. The particular adhesive used is not critical to the present invention since a number of readily available pressure sensitive repositionable adhesives are available.

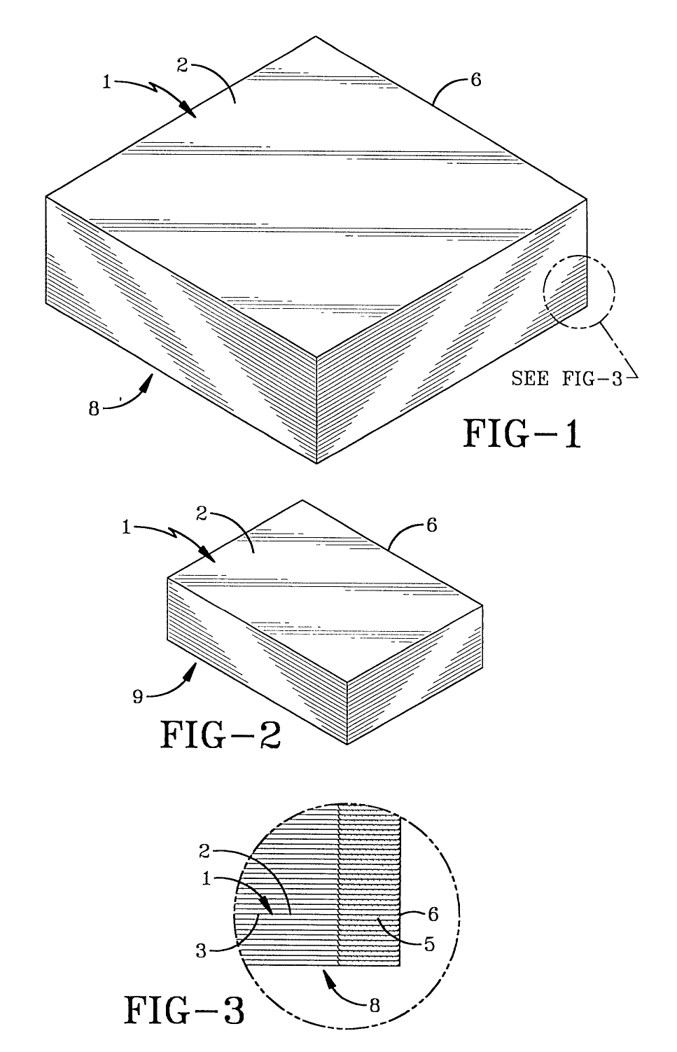

As shown in FIGS. 1-3, a plurality of note sheets 1 can be arranged in a stacked relationship to form a notepad 8 with adhesive 5 being pressed against the front sheet 2 of the adjacent sheet until the desired thickness of the notepad is achieved. FIG. 2 is similar to FIG. 1, but uses a plurality of smaller size sheets 1 for forming a smaller notepad 9. Preferably, the note sheets will be rectangular as are the presently used opaque self-adhesive note sheets and can be of various colors without affecting the transparency of the sheet. Likewise, the pads could have an oval or other geometrical shape without affecting the concept of the invention.

In the preferred embodiment, sheets 1 will be formed of a transparent cellulose fiber material such as cellophane and/or cellulose acetate, although other types of clear plastics could be used to achieve the same results. However, the use of a cellulose based paper-like material is preferred since it provides the desired transparency and reduced thickness and can be coated, if necessary, with a coating on the front side 2 thereof to be adaptable to receive various types of writing materials. Likewise, certain writing instruments can be used on such cellulose based material without requiring any coating being applied thereto.

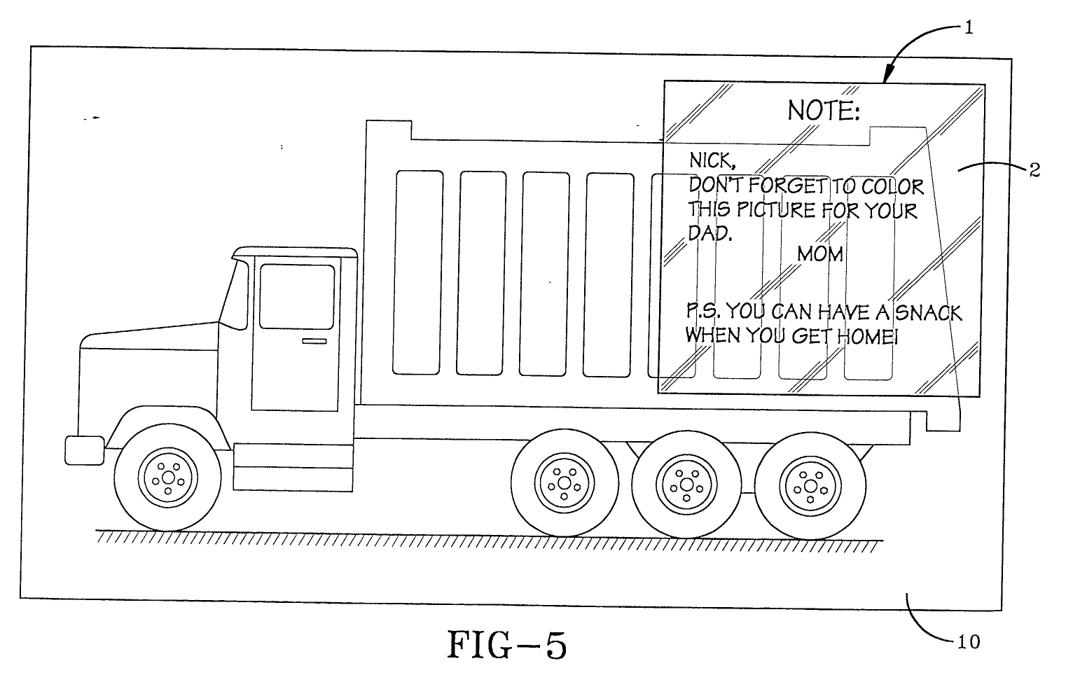

FIG. 5 shows one manner in which the improved note sheets 1 can be utilized where it is applied over a illustration 10 with various written notes or printed indicia being applied to front side 2 thereof. Note sheet 1 is attached easily to the document 10 by adhesive strip 5 and can be removed and will leave no tacky residue on document 10.

A further manner in which improved note sheets 1 is utilized is shown in FIG. 6 wherein a note sheet 1 is applied over an existing printed indicia 11 of a document 12, in which indicia 11 could be letters, numbers or other characters. The proposed corrections indicated at 14 are written on front side 2 of note sheet 1 and placed over the original indicia 11 on document 12 which will show a reader the original indicia and generally simultaneously therewith, the proposed changes thereto. This will also preserve the original indicia 11 until the proposed corrections are approved.

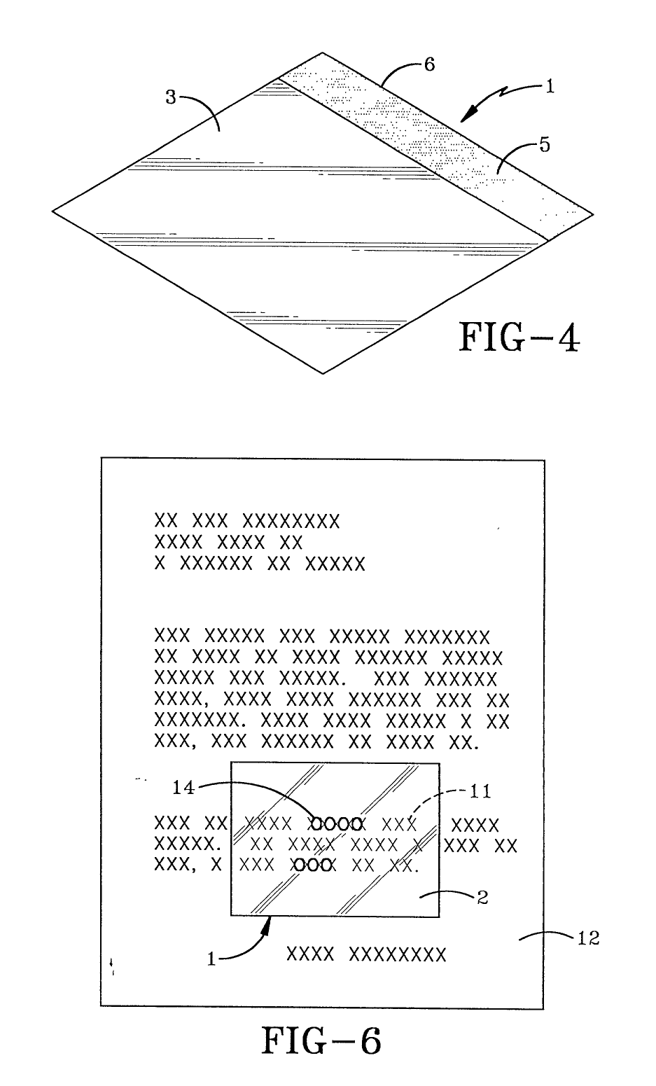

In accordance with a further feature of the invention, forming note sheet 1 of a transparent cellulose material enables the sheet to be considerably thinner than the usual opaque paper used for similar opaque adhesive note sheets. Sheet 1 preferably has a thickness within the range of 5 microns and 100 microns with the preferred thickness being generally 7-15 microns. Thus, as shown in FIG. 3, this enables a greater number of sheets to be placed in a predetermined height or thickness notepad and enables a number of sheets to be used on different pages of a multi-page document without materially affecting the thickness of the document. This reduced thickness also enables the sheet to pass more easily through an automatic feeder of a photocopy machine, printer or the like without jamming.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the description and illustration of the invention is an example and the invention is not limited to the exact details shown or described.

1. A notepad comprising:
a plurality of sheets, each sheet having a first side and a second side and formed of a transparent material, said first side being capable of being written on;
a layer of pressure sensitive adhesive adjacent an edge of a margin of the second side of each sheet; and
said sheets being stacked one upon another with the pressure sensitive adhesive on the second side releasably adhering to the first side of the adjacent sheet

2. The notepad defined in claim 1 in which the sheets are a cellulose fiber material.

3. The notepad defined in claim 1 in which the sheets are a cellulose acetate.

4. The notepad defined in claim 1 in which the sheets have a thickness in the range of 5 microns and 100 microns.

5. The notepad defined in claim 4 in which the sheets have a thickness of 7-15 microns.

6. The notepad defined in claim 1 in which the sheets are rectangular.

7. The notepad defined in claim 1 in which the adhesive is a repositionable adhesive.

8. The notepad defined in claim 1 in which the sheets are a paper material.

9. The notepad defined in claim 8 in which the sheets are a cellophane material.

10. A note sheet comprising:
a thin flexible sheet of transparent material having first and second sides, said first side being able to receive written indicia thereon; and
a pressure sensitive adhesive applied along a margin of at least one edge on the second side.

11. The note sheet defined in claim 10 in which the sheet is a cellulose fiber material.

12. The note sheet defined in claim 10 in which the sheet is a cellulose acetate.

13. The note sheet defined in claim 10 in which the sheet has a thickness in the range of 5 microns and 100 microns.

14. The note sheet defined in claim 13 in which the sheet has a thickness of 7-15 microns.

15. The note sheet defined in claim 10 in which the sheet is rectangular.

16. The note sheet defined in claim 10 in which the adhesive is a repositionable adhesive.

17. The note sheet define din claim 16 in which the sheet is a cellophane material.
